(19) United States
(12) Patent Application Publication
(10) Pub. No.: US 2006/0190392 A1
(43) Pub. Date: Aug. 24, 2006

(54) TradeChess: a game formatted trading environment

(76) Inventor: Gideon Samid, Rokville, MD (US)

Correspondence Address: Gideon Samid, 13 Tapiola Ct., Rockville, MD, 20850, US

(21) Appl. No.: 11/357,940

(22) Filed: Feb. 22, 2006

Related U.S. Application Data
(60) Provisional application No. 60/654,868, filed on Feb. 22, 2005.

(51) Int. Cl. G06Q 40/00

(52) U.S. Cl. 705/37

(57) ABSTRACT

A game-formatted trade environment where unlimited number of sellers and unlimited number of buyers interact for the purpose of exchanging goods for money in a format that presents a limited (known) risk to both buyers and sellers, along with the opportunity for unlimited high-price for sellers, and the opportunity for buyers to buy auction-style unlimited expensive goods against their fixed admission fee, and where the trade is transacted with game-currency that is given to buyers against their game admission fee, and is losing its value at game's end, so that buyers walk-away with the goods they purchased against the game currency, and the sellers divide among them the aggregate admission fee minus the profits of the game operator, and his cost, such that each seller receives a cut proportional to the purchase price of his or her goods as transacted with the game currency.

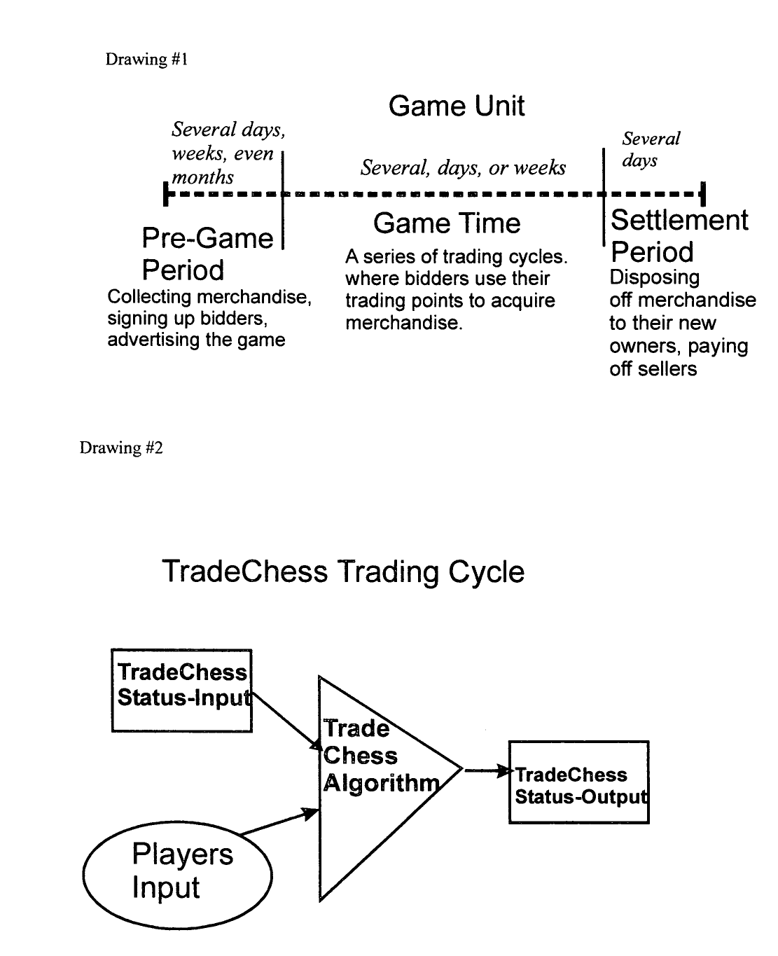

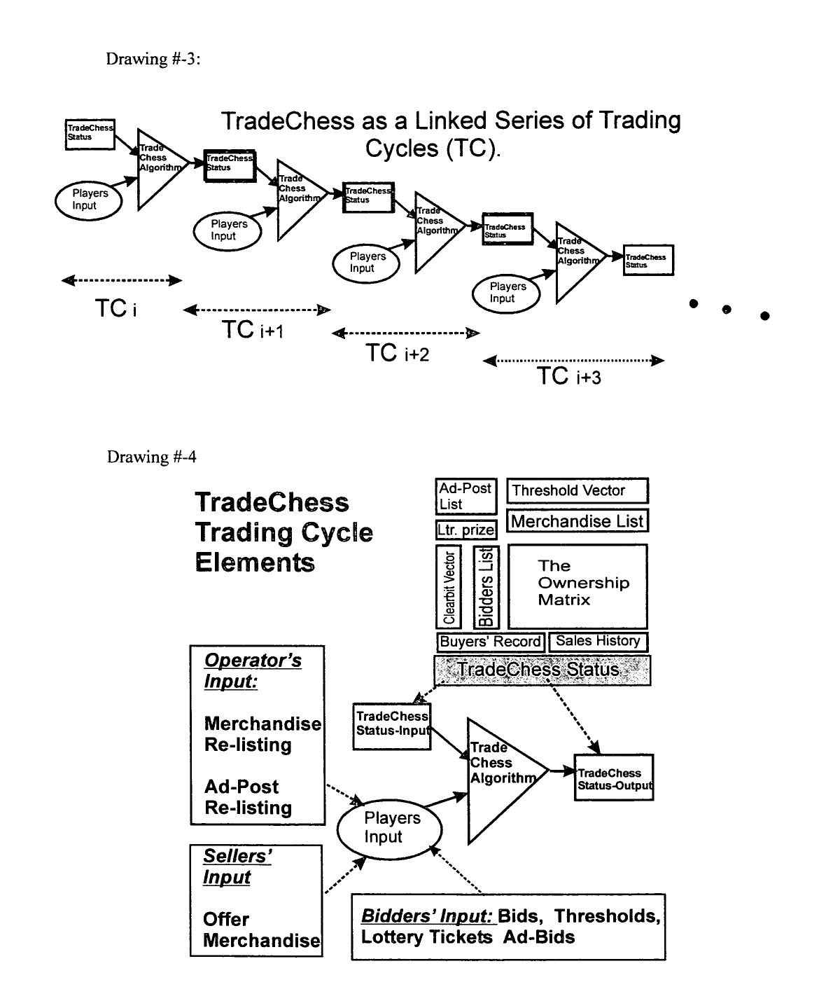

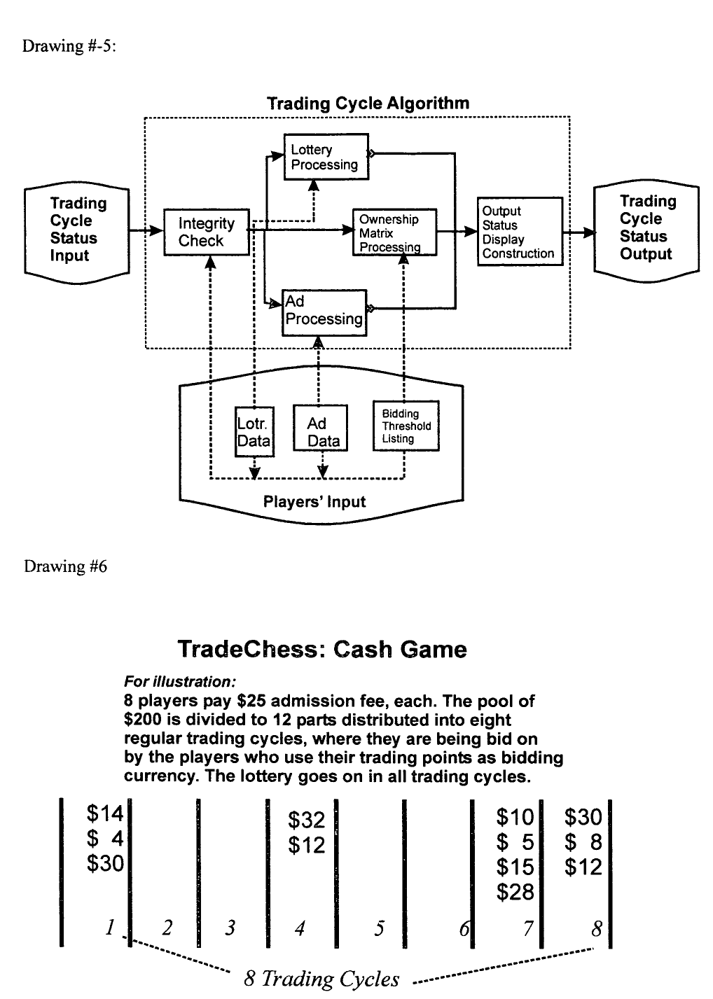

### CROSS-REFERENCE TO RELATED APPLICATIONS

This applications claims as priority date provisional application filed by the same inventor on Feb. 22, 2005, assigned No 60/654,868 confirmation No 4971, entitled “Prekey Mail & TradeChess.” (see appendix).

This invention has an association in part with a former invention by the same inventor: “Small Size, High-Volume Random Bits Container”, U.S. Utility patent application Ser. No. 10/115,961.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable

### BACKGROUND OF THE INVENTION

Telecommunication technology has revolutionized commerce and trade, enabling a larger number of sellers to reach a growing number of buyers for the common good. In parallel, modern computer technology allows for wide-cast games and lotteries, that may balance risk-reward to individual taste. This invention, TradeChess, combines the wide-range of possibilities found in a lottery, with the orderly, and common process of trade. Buyers and sellers cup their risk, and play in an unbound gain range. TradeChess can be played over the World-Wide-Web, or around-the-table. It opens new possibilities for trade, and develops new opportunities for buyers and sellers alike. The process is game-like, entertaining, and suspenseful.

Trading Price represents a meeting of minds between seller and buyer—at the very moment of the transaction, given all that happens around them. A price can change at an instant, and clever traders maneuver and steer to maximize their gain. TradeChess provides a framework for Internet, as well as for off line traders, to challenge their strategic thinking, and participate in a thrilling multi-cast game in which they can win big, or lose all, and everything in between. It's a matter of timing. It's a question of anticipating the moves of the other players; It's a case of reasoning under uncertainty; and like in life, luck has a role too. In TradeChess you don't buy with actual dollar currency. You trade, and optionally gamble with ephemeral bits, but you buy real, coveted, goods! The trading game starts with a ‘ready-set-go shot’, and it builds speed, momentum and thrill until the finish line—days later—where bits disappear, and the winners walk away with goods and cash. “TradeChess” kindles the fanfare of a casino, on a framework of an auction, carried with the pace of a thriller. Combine, in your mind, the utility of eBay, the excitement of a thriller, and the cerebral pleasure of chess, and you have gotten close. In a normal casino, or lottery, the operator cashes in on the irrational excitement of the players who put in a lot of money for a limited chance to win big. One or few walk away with a small fortune, but the bulk of the ‘irrational exuberance’ money goes to the game operator. In a commonplace auction, sellers generate an emotional drive among would be buyers, and thus jack up their price. However, both a lottery and an auction are essentially a momentary event. As human beings we are attracted to situations of thrill that develop over time. That's why a football game is not a 10 minutes event, and that's why a 7 page short story can not build the emotional attachment generated by a 600 page thriller. Add to this heart-felt excitement the cerebral satisfaction of wrestling with an intellectual challenge, and one ends up with all the ingredients needed for a combined platform where buyers and sellers strategize for advantage, over time, carried by the excitement of a daily surprise, and the thrill of who would laugh last. Paying with the risk of losing their “admission fee” traders buy the chance to benefit much more than without this format. Winners and losers—all share the thrill of playing. And what's more: the Internet. This multi-cast game can extend to all the corners of the planet, owing to the ubiquity of the World-Wide-Web. Add to this the final element: The Internet currency—and, now all that is needed, is to learn the rules, and start the game. TradeChess would benefit buyers and sellers because the excitement of the game would draw more admission fees from would by buyers, and the bulk of that fee would be siphoned to the sellers (as opposed to the operator, like in a lottery). The increased gain to the sellers would draw more sellers to the fray. More offerings, in turn, would, draw more buyers to be. That would mean a bigger pie to share among the sellers—drawing even more of them to the process. And yes—process: it's not over until it's over! A trading round takes place, say, every day, the built-up excitement allows for this upward spiral to keep fueling the TradeChess marketplace. And like in chess, every day, is an opportunity for a new move. A player can correct past mistakes, outsmart a fellow trader, and be catapulted to the top of the heap just before the “gong” that ends the final round. TradeChess may become the next interactive international pastime, and it's all for the good! Unknown artists, holders of rare items, remote sellers, should all benefit from TradeChess. Event promoters, trade shows, issue advocates, and of course charities would all gain from putting up a TradeChess session. A TradeChess session may last a week, a month, even larger. Sessions would be open to the public, but others would be limited to selected traders. Some sessions would involve small amount of money, some would be limited to the very rich. While the Internet is a natural environment for TradeChess, the game can be played by traders around a table, with the help of a simple computing device. Many TradeChess sessions can be run in parallel, grouping similar merchandise to attract a target crowd of contending buyers. Each TradeChess session operator would specify and tailor his own rules. What is common is the fusion of the draw of a lottery, the price hike of an auction, the excitement of a thriller, and the cerebral challenge of chess. To play TradeChess one needs to learn the basics—very fast, and very easy. But like chess, learning the basic rules is just walking in the door. The challenge of the game is in the wisdom to make each day the best possible move.

### BRIEF SUMMARY OF THE INVENTION

The TradeChess invention creates an environment where some sellers, and some buyers join in a “game” in which the sellers' merchandise is sold against a game-issued game-currency, which buyers receive for their admission fee. The game-currency loses its value at the end of the game, but some buyers walk away with certain merchandise they bought with the game currency. The sellers divide among them the proceeds of the admission fees, minus operational cost and operator's profit. Each seller is remunerated in proportion to the selling price of his or her merchandise, as it was auctioned off against the game-currency. Buyers who walk away with merchandize that its value is higher than the admission fee, are big winners; sellers who sold their merchandise in games with a large number of buyers, would get a much higher price for their goods than their nominal value (in any other trading environment). So while in any other trading situation if the buyer is happy the seller is unhappy, and vice versa, in TradeChess, both the seller and the buyer may walk away with great profit. This is possible because there are some would-be-buyers who failed to buy anything, and just lost their admission fee. It is essential to TradeChess that the trading is executed with “ephemeral currency” that “evaporates” at the game's end, while the remuneration to the sellers is made from the admission fee, which by contrast is hard currency, while the buyers walk away with the merchandise they have successfully bid on in the game. The vitality and dynamics of the game is assured by the fact that it makes no sense to hoard game currency, because its value is limited to the duration of the game. Alas, this game currency is the only currency accepted for bidding on the for-sale merchandise. This divorce between the trading currency, and the sellers remuneration currency (the hard currency of the game admission fee), is essential to TradeChess, and it creates the situation where buyers can buy what they desire for a fraction of what they would have to pay in a regular store, or regular auction, while sellers who risk getting less than nominal for their goods, stand the chance to be paid considerably more than in any other trade environment. Success is a matter of game popularity, and the co-influence of the various pieces of merchandize offered for sale in a particular game, as well as a matter of judgment, strategy, and discipline. The TradeChess game is comprised of a predetermined number of trading cycles, which may last for several days or longer. TradeChess introduces a small element of “luck” through a lottery based on random number generation, and it is designed to allow for upsets, last minute turn around, and other “suspenseful” tricks, designed to capture the fancy of the players, and draw more buyers and more sellers into a profitable interaction.

### DETAILED DESCRIPTION OF THE INVENTION

TradeChess is a trading environment constructed as a game, comprised of a set of rules and procedures that allows its players to achieve their interdependent goals. TradeChess combines the thrill of a game with the utility of a trade.

The framework of the TradeChess is comprised of the following elements interacting and executing the game process according to the game's rules and procedures.

2.1. Players' AIM

The TradeChess players are:
The TradeChess Owner
The TradeChess Nominal Beneficiary
The TradeChess Operator
The TradeChess sellers
The TradeChess buyers
   2.1.1. The TradeChess Owner

The TradeChess owner owns the intellectual property, (IP), for the TradeChess game. His goal is to build the game as a viable, ubiquitous trading and entertainment tool. To achieve this goal, the owner wishes to refine the game's rules and procedures to be fair and balanced among the other game players. These players must develop a sense of gratification to continue playing. The owner would forgo short range profit in favor of his viability and ubiquity goal.

2.1.2. The Nominal Beneficiary

The nominal beneficiary is an optional player who wishes to use the TradeChess game to promote and further an event, an issue, or some goal. In general, the nominal beneficiary would desire a game which is creating a big ‘splash’ and makes ‘noise’ that translates to advertising and promoting the beneficiary's goal.

2.1.3. The TradeChess Operator

The TradeChess operator is a licensee or a franchisee of the game owner, and he puts up instances of the game serving the other players. His goal is to run a game that would satisfy the largest number of players, would get good publicity, and would enhance his reputation as an effective game operator to further his business as a TradeChess game operator.

2.1.4. The Sellers

The sellers are people or organizations with merchandise to sell. Their goal is either to sell something that they could not easily sell otherwise, or sell merchandise for the purpose of generating interest in other activities by using such a public stage; or, more plainly, to sell at a higher price. Sellers are aware that TradeChess involves uncertainty which means that they risk selling for less, while enjoying the opportunity to sell for more. When the a game session ends, the sellers might get their merchandise back, if nobody bought it. Otherwise, the sellers part with their merchandise, and receive cash, or cash equivalent in return. The amount of cash they receive is calculated based on the rules of the game. In general, the sellers have the chance to sell his merchandise for much more than the nominal marketplace would bear, but then again, the selling price may be that much lower. A seller who agrees to participate in the game must be aware of this unusual risk.

2.1.5. Buyers

Buyers are people or organizations interested in the merchandise offered by the sellers. They either cannot get the same merchandise elsewhere, and so they have to play to get what they want, or they hope to use their strategic playing ability and good luck to buy the offered merchandize for less than elsewhere.

Unlike a nominal market place, buyers in TradeChess are not guaranteed a purchase. They might end up paying to participate but failing to purchase anything they want. Buyers must be made aware of this risk. They may be well disposed towards this risk for the opportunity to purchase their coveted item for less than otherwise, or perhaps because their coveted item is not to be found elsewhere.

2.2. Elements

Human/Organizational Participants

Technology Elements

The Transacted Goods

Game Constructs

2.2.1. Human Elements

The human elements of TradeChess, the “players” are the following, as discussed above:
The Nominal Beneficiary, the game owner
The Operator
The Sellers
The Buyers (The Bidders)
   2.2.2. Technology Elements

Categories:
Communication gear
computing machines
electronic currency
   2.2.2.1. Communication Gear

The players are constantly in mutual communication. If the players are physically collocated, they can share one or two displays and thus achieve the needed communication. However, if the players are Internet-connected, then the communication would be carried out via the World Wide Web, through a TradeChess server. The operator would use the server to operate a TradeChess Web-site, and the other players would communicate through the site, using standard protocols.

2.2.2.2. Computing Machines

TradeChess is operated through simple logic and arithmetic. It also features a pseudo-random number generator (PRNG). If TradeChess operates with book-keeping currency, then the overall computing load is very simple, and can be accomplished via a hand held device or a lap top computer, even for a relatively large number of players

2.2.2.3. Electronic Currency

Like any trading environment, TradeChess works with a currency that is used to pay for merchandise. There are two operational modes with respect to currency:
book-keeping mode
ClearBIT mode

The first is the simpler method, but the second allow for anonymity, and a sense of tangibility. In either mode, the name of the currency would be ClearBITs: Bits that clear at the end of the game.

2.2.2.3.1. Book Keeping Currency

In this mode the players would manage their currency through the operator software. Each buyer would have TradeChess currency “points” (clearbits) allotted to him on the game's database, and the movements of currency would instantly be available for examination. In this mode currency is virtual, there are no digital coins exchanged between players and the game. Everything is done on the books.

2.2.3. The Transacted Goods

In theory, anything that is transactable elsewhere can be transacted in TradeChess. However, owing to the special features of TradeChess, there is an advantage to goods which have no clear dollar value comparison elsewhere. Such are art work, one-of-a-kind items, like used articles, etc.

2.2.4. Game Constructs

The TradeChess game defines game elements:

Game Unit or Market Session

This is a trading arrangement where bidders vie for a list of merchandise, using trading points (clearbits), which they receive against their admission fee. A game unit consists of several consecutive trading cycles, at the end of which the bidders receive the merchandise awarded to them in the bidding process, and sellers receive their proportional cut from the sum of the admission fees.

Bidding Currency/Trading Points/Clearbits

This is the currency used by bidders to bid on merchandise. Bidders get a set of trading points against their admission fee

Buyers Admission Fee:

Fee paid by would be buyers in order to get trading points, and admission to “play”—participate in the game unit.

Sellers Pay

Payment disbursed to sellers who put their merchandise for sale on a particular game unit. Sellers pay is proportional to the latest winning bid for their merchandise.

Trading Cycle

A period in the game unit in which the players, (the operator, the sellers and the bidders), “play”—meaning, make moves, like bidding. At the end of a trading cycle the game status that started the cycle is changed to a new game status that starts the next cycle.

Lottery

An arrangement whereby the trading points collected by the operator are put up as a lottery win. Bidders may buy lottery tickets with their trading points. The more tickets they buy the greater their chance to win the lottery. The winner can use his win in the next trading cycle.

Advertising Board A space visible by all players which is shared between the operator putting up announcement of his choice, and between bidders who bid on an advertising spot, and can use it to communicate to other bidders.

Rules of the game A set of very specified rules that the operator obligates himself and the other players to abide by. The rules are comprised of the basic rules described here, and specified rules which are the discretion of the operator.

2.3. The TradeChess Game Process

We first provide an overview, and then delve into the details according to the following categories:
Pre Process
Transaction Process
Settlement Process
   2.3.1. Game Overview

TradeChess is essentially a bidding game. Several would-be buyers bid for a slate of merchandise. Unlike a normal bidding situation, in TradeChess: the bidding currency is ephemeral—it loses its value at the end of the bidding process. The bidding happens as a succession of bidding cycles, which eventually terminate. These are the key concepts of TradeChess. Would be buyers pay an admission fee that provides them with ephemeral bits—the TradeChess currency. Only these bits would be a valid bidding currency for any merchandise to be had. A winning bidder pays with his bidding bits, and gains possession of the bid-upon merchandise. In the coming trade cycles, other traders may make an offer to a previously successful bidder. The latter might need those bits to bid on another piece of merchandise. Articles of merchandise, thus, may change owners from one trading cycle to another. When the trading cycles come to an end, the bidding bits lose their value, and the current owner of each item of merchandise walks away with his new purchase. The accumulating admission fees, minus the standard cut, are then distributed to the sellers in proportion to the bit value of their last transaction. This structure is opening-heavy, in the sense that most of the excitement happens in the first rounds. Pretty soon, buyers exhaust their bit supply, and thus lose their bidding power. To counter that TradeChess incorporates in every bidding cycle a lottery round.

2.3.1.1. A Basic TradeChess Game Illustration (E 1.0)

(E.1.01) Three sellers offer three pieces of merchandise: a ring, a pen, and a watch. Four people pay the admission fee for the right to bid on these items: Alice, Bob, Carla, and David. Each of the bidders get 100 TradeChess trading bits.

Alice likes everything on the market. Bob likes the ring more than the rest. Carla is totally focused on the ring, and David can not make up his mind between the pen and the watch. These dispositions lead the four to allocate their bidding bits, on the first bidding cycle as follows:

| | ring | pen | watch |
|---|---|---|---|
| Alice | 34 | 33 | 33 |
| Bob | 60 | 20 | 20 |
| Carla | 100 | 0 | 0 |
| David | 0 | 50 | 50 |

By the end of the first trading day, Alice and Bob own nothing, Carla owns the ring, and David owns the pen and the watch. In the coming trade cycles Alice and Bob try feverishly to bid on any of the pieces of merchandise, but Carla and David don't budge. Carla got her coveted ring, and has no interest to trade it for any number of bits, which are about to evaporate anyway. David has had no interest in the ring, and he already owns the other two items, so he too has no interest to accept the bids of Alice and Bob. Suppose now that Carla's total focus on the ring would have suggested to David that the ring of great hidden value. David would still choose not to trade neither the pen, nor the watch against trading bits since he reckons that Carla would not sell the ring for any price, so he has no use for bits. And so, after however many trading cycles, this particular TradeChess game comes to its end, and Carla walks away with the ring, while David pockets the pen and the watch. Alice and Bob have nothing to show for the admission fee that they paid to get to play. Let's say that the admission fee for the game was $50. The operator has collected $200=4*$50. He takes a 10% operational cost, and another 10% profit, and the remaining fund: $160=200*80% is then distributed among the sellers in proportion to the last selling price of each item. Hence the seller of the ring gets $80, and the sellers of the pen and the watch get $40 each. Now suppose that the operator had managed to attract two more bidders: Eve and Frank (E.1.02). These traders had equal interest in all three offerings, and had distributed their bits similar to Alice.:

| | ring | pen | watch |
|---|---|---|---|
| Alice | 34 | 33 | 33 |
| Bob | 60 | 20 | 20 |
| Carla | 100 | 0 | 0 |
| David | 0 | 50 | 50 |
| Eve | 30 | 37 | 33 |
| Frank | 35 | 33 | 32 |

In this case, again Carla would end up with the ring, and Frank with the pen and the watch, and neither one would agree to trade their takes. However, the admission fee fund would tally $300=6*$50. And $240=$300*80% would be left for distribution to the sellers. The ring seller would receive $150 (instead of $80 as before), and the watch and pen sellers would each receive $75 (instead of $40). This illustrates the attraction of TradeChess for sellers. The more bidders, the better their take, which is the flare of the lottery in the game. (E.1.03) Now, assume that David was hesitating between the ring and the pen, instead of between the pen and the watch:

| | ring | pen | watch |
|---|---|---|---|
| Alice | 34 | 33 | 33 |
| Bob | 60 | 20 | 20 |
| Carla | 100 | 0 | 0 |
| David | 50 | 50 | 0 |

Carla would have received the ring, as before, David would have owned the pen, but Alice would have taken possession of the watch. Bob would have remained the only player without a purchase. In subsequent trading cycles Bob could tempt Alice with his unused 100 bits to buy the watch for which she paid only 33 bits. However, Alice would reason that she had precious little to do with all these bits: neither Carla, nor David was disposed to sell their goods, and anyway she had equal interest in the three offerings. And the end of this TradeChess game, the same $160 dollars would be available for distribution among the sellers. This time the ring seller would receive: $87.43=$160*(100/100+50+33),. (Almost $8 more that in the first case E.1.01), while the pen seller would receive: $43.71=$160*(50/(100+50+33), $3.71 more than before, alas the watch seller would receive: $28.85=$160*(33/(100+50+33) $11.15 less than before. In other words, the bidding distribution of the buyers affects seller's compensation. Let's assume now (E.1.04) that some days into this TradeChess game, a poor painter decided to offer one of his painting as a forth article of merchandise. David fell in love with the picture and bid on it the remaining 50 bits in his possession. Albeit, Alice who had no interest in the picture decided nonetheless to bid on it with her full reserve: 67 bits—since otherwise those bits would evaporate anyway. Bob, on the other hand decided to pass, contemplating that before this session ends someone would offer other goods, and Bob—being cash rich—would secure its possession: mid cycle:

| | Cash | Carla's | David's | Alice's | operator's |
|---|---|---|---|---|---|
| | Reserve | ring | pen | watch | painting |
| Alice | 67 | 0 | 0 | 0 | 67 |
| Bob | 100 | 0 | 0 | 0 | 0 |
| Carla | 0 | 0 | 0 | 0 | 0 |
| David | 50 | 0 | 0 | 0 | 50 |

So the painting goes to Alice. David itches to buy the painting from Alice and thus he puts his pen for sale. Bob suspects as much, and offers his 100 bits for that pen. He gets it, and David bids for the painting with his treasure of 150 bits. Alice has no interest in the painting, and she accepts the offer, gambling that a new seller would come along, and then she can secure the new merchandise with her unmatched bank account of 150 bits. If no new seller shows up, Alice simply loses her bank account like the rest of the players. The introduction of the painting has substantially changed the compensation for the sellers: The ring seller receives $41.78=$160*100/(100+100+33+150). Recall that the ring was sold for 100 bits, the pen was originally sold for 50 bits, but resold for 100 bits. The watch was sold once for 33 bits, and the painting was first sold for 67 bits, and resold for 150 bits. We see then that the ring seller who expected to get $80 for his ring, would have ended up with essentially half of that sum, while the unknown painter would net: $62.66=$160*(150/(100+100+33+150)—remindful of a horse race upset.

2.3.1.2. The TradeChess Lottery

The clearbits (game currency) collected by the game operator for merchandise initially posted are tallied each round, and are put up for a lottery take. Each of the bidders is eligible to buy a lottery ticket with any clearbits at its disposal. The winning chance for each bidder is proportional to the number of bits paid for that lottery. One can say that each clearbit buys a single lottery ticket. The more ticket one buys, the greater her chance to win. The number of lottery tickets purchased each bidding cycle is secret, so no bidder knows how much the others have bid on that lottery. At the end of the lottery cycle, the lottery is run, one bidder wins all the clearbits which were put up as the lottery prize, and the rest lose their bidding clearbits in favor of the operator. If no one bought a ticket the money accumulates for the next cycle. When new merchandize is offered in the game, its purchase price is owned by the operator and is added to the lottery prize for the next round. Also the clearbits form the losing tickets are owned by the operator, and are added to the lottery prize in the next round. In other words, the operator does not keep clearbits for itself. Whatever it collects each bidding round, it puts up for the next round lottery.

2.3.1.2.1. Lottery Example

Recall the first example (E.1.01):

The first round bidding were follows:

| | ring | pen | watch |
|---|---|---|---|
| Alice | 34 | 33 | 33 |
| Bob | 60 | 20 | 20 |
| Carla | 100 | 0 | 0 |
| David | 0 | 50 | 50 |

As a result the operator owns 200=100+50+50 clearbits, which will be put forth for the next round lottery. Alice and Bob, each has 100 clearbits, since they failed to buy anything, and what's more, they reason that they have no chance to buy any of the merchandise items from the their current owner, so they might as well use their money to gamble, and possibly gain a chunk of clearbits with which to secure the purchase of some new merchandise added to the game in a later round. Alice decides to gamble with all her 100 clearbits, but Bob reckons that he might parcel his bits across several lottery rounds. Carla has no “cash”, no clearbits to buy a ticket, and David decides to buy two tickets, for 25 clearbits each, one for the coming round, and one for the next round. In summary:

| | unit-tickets bought | winning chance: |
|---|---|---|
| Alice | 100 | 61% |
| Bob | 40 | 24% |
| Carla | 0 | 0% |
| David | 25 | 15% |
| total: | 165 | 100% |

Let's say that Alice wins this lottery. She now has a net gain of 100 clearbits (200 clearbits she won, 100 clearbits she paid for the tickets to win). Bob, and David are short 40 and 25 clearbits respectively. The operator has now 165 clearbits to be put forth for the next lottery. Come to think about it, Alice was not too smart because after winning the first lottery she ends up with the same number of clearbits! It does not make sense to buy tickets for half or more of the lottery sum! The bidders lose hope for a new piece of merchandise to join the game, and they neglect to buy tickets, since they deem the clearbits useless. Except David who follows on his plan to bid the other 25 clearbits. Since David is the only ticket buyer, he is the sure winner. If David had known that nobody else buys tickets he would have bought only a unit ticket for 1 clearbit, and won the lottery all the same. As it stands now, David's net gain is 140 clearbits=165−25. He became the richest bidder, and when the painting comes in as in the previous example, David can secure it for himself since no one can outbid him.

2.3.1.3. Game Advertising

The game platform will feature a number of advertising spots which may be used by bidders to communicate to other bidders. They may exalt the attribute of a piece of merchandize they own and wish to resell. They may promise a good price threshold or, they may even offer to sell clearbits they don't need to willing bidders, if the rules permitted. Each trading cycle the advertising spots are up for sale. Interested bidders can offer to pay any amount of clearbits they choose for a spot. The operator would grant the first spot to the highest bidder, the second spot, to the second highest bidder, and so on, until the last spot is filled. Obviously, if there are more advertising spots than bidders, then everyone would bid one clearbit and get a spot. The fewer the advertising spots, the tighter the competition for them, and since no bidder knows what the others have offered for an advertising spot, no bidder can be sure that his offer would net him with an advertising spot the next trading cycle. The bidders who don't get an advertising spot would get their money back. The money paid for these spots goes to the operator, and is added up to the lottery prize for the next round.

2.3.1.3.1. Advertising Example

We recall our first example (E.1.04): mid cycle:

| | Cash | Carla's | David's | Alice's | operator's |
|---|---|---|---|---|---|
| | Reserve | ring | pen | watch | painting |
| Alice | 67 | 0 | 0 | 0 | 67 |
| Bob | 100 | 0 | 0 | 0 | 0 |
| Carla | 0 | 0 | 0 | 0 | 0 |
| David | 50 | 0 | 0 | 0 | 50 |

Suppose that when the painting appeared as a merchandise, David wished to sell any of his possession to secure the painting, while Alice wanted to buy some clearbits to secure the painting, and Bob offered his clearbits for sale. All three needed an advertising spot. They decided to buy a spot with the following offerings:

Offers to buy an advertising spot

| | |
|---|---|
| Alice | 10 |
| Bob | 20 |
| David | 15 |

The first advertising spot goes to Bob, the second to David, and none to Alice. The operator gains 35 clearbits=20+15, which would be added to the next lottery prize. Alice gets back her 10 bits.

2.3.2. TradeChess Pre-Process

To run a TradeChess market session, the operator needs to prepare the following: Define the aim, the rules and the parameters of the coming game.

Secure a starting slate of sellers. Register a starting slate of bidders. Hire an outside auditor. Insure legality

2.3.2.1. Define the Aim, the Rules, and the Parameters of the Coming Game

TradeChess is played as individual independent games, which can run in parallel, or in series. A game is a TradeChess market session which lasts for a certain number of bidding rounds, and at the end some buyers walk away with merchandise, and sellers receive payments for their goods. We discuss here how to define such an individual game.

We focus on:

defining aim and scope

defining game parameters

defining game rules

2.3.2.1.1. Defining Aim and Scope

Every game has an aim and a scope which guide its detailed design.

Possible aims:

Use the TradeChess game to maximize profits for the operator.

Use the TradeChess game to promote an event or an issue.

Use the TradeChess game to help a charity or a cause

Use the TradeChess game to help a group of sellers

2.3.2.1.1.1. Profit Making

With this aim in mind, the game operator would seek the most profitable group of sellers, and the most eager group of bidders, offering possibly many smaller, short lived games that would be tailored to maximize operator's gain. The games would be heavily promoted to attract the best possible sellers and bidders. There would be no concern as to the nature of the goods for sale, or for any metrics of fairness to sellers or bidders of the game.

2.3.2.1.1.2. Event Promoting

Events that involve a large number of people that must be attracted to participate may be promoted by tying a TradeChess game to play some time before the event, and to terminate within the event. Bidder's admission fee would be hidden in the registration cost, and the merchandize might be tailored to the interests of the participants.

The tied-to event may be a celebration of some sort, an anniversary, a conclusion of some class or a semester, etc.

2.3.2.1.1.3. Promoting a Charity

This is a unique purpose. Much of the bidders' admission fee would benefit the charity, and the sellers may be persuaded to contribute their merchandise to attract more bidders.

2.3.2.1.2. Defining the Game Parameters

The major game parameters are:

the nature of the merchandise.

the characteristic of the sellers and the buyers.

the duration, timing, and trading cycles of the game

advertising and promotion.

platform and technology

financial parameters

2.3.2.1.2.1. The Nature of the Merchandise

While the game would work with any combination of unrelated merchandise, in practice the merchandize would have to be tailored to the targeted bidders and their interest. If the game promotional message would target art lovers then the merchandize should better be art, and art related articles. The same for sports fan, or fans of a particular band or singer.

2.3.2.1.2.2. The Characteristics of the Sellers and Buyers

A successful TradeChess game would require a tight definition of target sellers and target buyers to match.

2.3.2.1.2.3. Duration, Timing and Trading Cycles of the Game

Once a game is announced and set up, (announcement date), it must define a starting day, when the bidding starts, a finish period, when the game comes to an end, and a final settlement date, among them:These four dates define: (See drawing #1)

A pre-game period

game time and trading cycles

settlement period

2.3.2.1.2.3.1. Pre Game Period

The pre game period would comprise from the announcement date to the start date. During this period the game parameters would be advertised and available to the bidding public and to potential sellers. The public will be able to review the initial slate of offered merchandise, study them and evaluate any interest anyone might have in coming aboard, paying the bidders admission fee, and carving out a bidding strategy.

2.3.2.1.2.3.2. Game Time and Trading Cycles

This is the time from the first trading cycle to the last one. The number of trading cycles, and their period is a critical parameter. TradeChess is based on building tension from start to finish. Yet, if the game lasts too long, bidders might be discouraged in waiting so long to get their merchandise. On the other hand, a longer lasting game allows for more lottery cycles, and for greater opportunity for sellers and for bidders to join in. Short cycle times create a fast pace, but may be too imposing on the players who use the game for a mixture of utility and entertainment. Trading cycles may start long, and become shorter towards the finish point when the tension is high.

2.3.2.1.2.3.3. Settlement Period

Settlement period is the time after the game finishes and in which the merchandise is distributed to the winning bidders, and the compensation is paid to the sellers. It is the time to raise complaints and issues. When this time is over, the issues of the game are over.

In defining the settlement period, the operator would define:
the disposition announcement timing
the challenge period
the delivery period.
   2.3.2.1.2.4. Advertising and Promotion

The more bidders and the more sellers join in, the more successful the game. And thus the game owner would be well advised to invest in promoting the game after it has been announced and before and after the first trading cycle. When a particular TradeChess game is focused on a well defined class of merchandise, it can also tailor its promotion to interested sellers and bidders.

2.3.2.1.2.5. Platform and Technology

The operator must decide on the exact technological elements to be used in the game. There must be effective and seamless communication among the players, there must be good security to frustrate hackers and intruders, and there must be proper backup in case of software, hardware or power failure.

2.3.2.1.2.6. Financial Parameters

These are:

The expected revenue.

The expected cost

Profit outlook.

Investment requirement

Financial sources.

risk analysis

2.3.2.1.2.6.1. The Expected Revenue

This figure computes as a multiplication of the bidders admission fee times the number of bidders throughout the game.

2.3.2.1.2.6 2. The Expected Cost

Major cost items:

Technology and Communication

Advertising and Promotion

Operational cost.

Cost of auditing and legal services.

2.3.2.1.2.6.2.1. Technology and Communication Cost

These are cost associated with setting up a powerful server, and Web software to service the players.

2.3.2.1.2.6.2.2. Operational Cost

This is the cost associated with manning the server and the game center with technology people, and administrative and executive personnel.

2.3.2.1.2.6.3. Risk Analysis

The risk for the entrepreneur is non trivial. The game may be announced, but bidders don't come. Some anchor sellers may have to be promised a minimum pay for their merchandize, and if not enough bidders show up, then the entrepreneur will have to cover the difference. And definitely the operational, legal and promotional cost would have to be covered. There is therefore an advantage to starting small, and gaining experience with bidders and what is needed to attract them

2.3.2.1.3. Defining the Rules of the Game

Within the general framework of the TradeChess game, there is room to specify and tailor some critical parameters. Like:

1. Does a merchandise owner expose the trade threshold for his merchandise?

2.3.3. The Transaction Process

The transaction process is a series of trading cycles from the first to the last. TC₁, TC₂, TC₃, . . . TC_{f}.

The first r cycles comprise the regular trading period, and the final (f-r) cycles comprise the termination period. The value of f is determined when the termination period starts through the termination period determination procedure.

Mapping the trading cycle onto the calendar is accomplished in the pre-processing phase of the TradeChess game. Same for the value of r.

The trading cycles are linked as follows:

TradeChess status—input, and players input is operated on by the trading cycle algorithm, to produce a TradeChess status—output. The latter serves as input for the next trading cycle. (see drawing #2)

Below we describe the procedure to determine the number of trading cycle in a TradeChess session, or a “game”, then we describe the making of each trading cycle, and finally we define the first and last trading cycle. (see drawing #3)

2.3.3.1. The Termination Period Determination Procedure

The nature of the TradeChess game disfavors an a-priori determination of the last trading cycle. Therefore one must adopt a procedure to determine the last trading cycle.

The standard way to do so is to first determine a regular period which would consist of r trading cycles, and then to specify a termination period of length, (f-r) cycles, where f is not a-priori known to the bidders.

There are two ways to do it:

Secret determination by the game operator.

Stochastic determination

The difficulty with the first method is that when the game is over someone may raise the claim that the operator chose the value of f to favor one player against the other. A stochastic determination may be replayed to prove fairness.

2.3.3.1.1. Stochastic Determination of Termination Period

There are several ways to accomplish this determination. The standard one is the limited “Russian Rolette”: The operator determines a factor φ, such that for every trading cycle after the regular period, there would be a chance of 1/φ for it to be the last one. In a classical Russian Rolette φ=6, and every trading cycle in the termination period has a chance of ⅙ to be the last one. The chance for the termination period to last at least (f-r) periods is: P_{f-r}=(1−1/φ)^{f-r} Thus, with a standard Russian Roulette there is chance of 16% for (f-r)≧10 For practical reasons the operator might set fₘₐₓ, thus when the stochastic determination lingers too long, it is artificially ending at a predefined limit.

2.3.3.2. Describing a Trading Cycle

We first define the elements of the trading cycle, then describe algorithms that operate and produce those elements, and finally we outline the time line of events in the trading cycle.

2.3.3.2.1. Trading Cycle Elements

The elements of the trading cycle are:
The TradeChess status—input and output
Players Input
The Players' Visibility Filter
   (see drawing #-4)
   2.3.3.2.1.1. The TradeChess Status

The TradeChess status is comprised of:
1. The merchandise list
2. The bidders list
3. The clearbit vector
4. The threshold vector
5. The Ownership matrix
6. The Advertising table
7. The Lottery Prize
8. Sales History
9. Bidders' Transaction History
   2.3.3.2.1.111. The Merchandise List

This is the list of the items of merchandise offered for sale at this TradeChess market session. The list is a set of tuples of the form:
Id—Name—bidding status—class—quantity—description—seller information
Id: is a running identifier 1,2,3, . . . that uniquely identifies this piece of merchandise. The id is the information that is carried in other tables and lists.
Name: This is a descriptive name for the merchandise.
Bidding Status: This is a binary data field: biddable/not-biddable
A biddable merchandise is made available for bidders to bid on, and to purchase. A not-biddable merchandize is not offered for bidding in the trading cycle that refers to this status as input.

The game operator controls the status of merchandise to enhance the game.
Class: The class parameter is a binary identifier:

Unique/Duplicative

A unique merchandise is one that has no duplicate, like an original painting, a piece of antique, a book with a handwritten note by the author. A duplicative merchandise has duplicates: like a published book, or a numbered duplicate of a painting.
quantity: Quantity is always I for unique items, and can be any integral number for duplicate items.
Description: This is a data element that provides detailed information about the piece of merchandise. It has a free format, and may include, text, graphics, sounds, etc. It may be of a large size, and be linked to data sources which would further describe the merchandise.
Seller Information: This section would identify the seller, contact information, contractual information, and date/time of receiving his merchandise for sale.
   2.3.3.2.1.1.2. The Bidders List

The bidders list is a series of tuples of the following format:

id—name—game handle—date/time of admission—payment status—contact information—contractual information—notes

id: This is a unique identifier in the form of a running integer: 1,2,3 . . . It is used by other tables to refer to a particular bidder.
name: This is the name of the individual or organization who became a bidder in this game.

This field is optional. Some bidders would wish to remain anonymous.
game handle: This is a name by which the bidder would be known to the other players of this TradeChess game. It would generally be the bidder's own choice. It may be identical to the real name of the bidder, or something completely different.

date/time of admission This is a record of the date and time in which this bidder enlisted as a bidder in the game. This information is crucial to resolve bidding conflicts.

Generally, the earlier registrant has an advantage.
payment status: This group of parameters would specify:
   admission fee
   pledge status
   method of payment
   collection status
   clearing status

Admission fee would specify amount and currency. Pledge status would indicate whether or not the bidder had made a firm pledge to pay, and a firm pledge to abide by the rules of the game, and a reference to finding the document or the evidence of the pledge. Method of payment would refer to the prospective or de facto way of payment: cash, check, credit card, other.

Collection status refers to a series of steps to be taken vis a vis delinquent bidders from gentle reminder, to warnings, and finally ultimatum to pay against the threat of removing the bidder from the active bidders list.

Clearing status indicates whether the payment made by the bidder actually cleared the system, and is irrevocably deposited in the operator's account.
contact information: This group of parameter would capture the various addresses and modes of communication with that bidder: physical address, mail/package address, email address, phone numbers, fax numbers.
contractual information: This parameter would provide a binary signal on whether or not the bidder has undertaken the standard contractual obligations expected of him, as well as a reference to the contract documents.
Notes: This section would point to where more information about the bidder is to be found, as well as anything else not covered by the parameters above.
   2.3.3.2.1.1.3. The Clearbit Vector

The vector is a simple list that specifies the number of clearbits available for each of the b bidders i=1,2,3, . . . b, as well as the clearbits available to the operator (regarded as bidder number 0):

X₀, X₁, X₂, X₃, . . . X_{b}

This vector may be explicit or implicit. If TradeChess is implemented in the book-keeping mode, then the vector would be explicit. If it is implemented in the ClearBIT currency mode than it would be explicit.

2.3.3.2.1.1.4. The Threshold Vector

This vector identifies for each piece of merchandise what is the threshold of an offer that would be acceptable to the seller of a TradeChess merchandise. Any offer below the threshold would be rejected. The threshold is a natural number.

Th₁, Th₂, Th₃, . . . Thₘ

The threshold for each merchandise is set up by the merchandise owner.

2.3.3.2.1.1.5. The Ownership Matrix

A matrix comprised of b+1 rows, and m columns: O[b,m].b—is the number of bidders, and m is the number of pieces of merchandise.

The element o[i,j] of the matrix is a binary digits indicating whether bidder i owns merchandise j.

O[i,j]=1 if bidder i owns merchandise j O[i,j]=0 if bidder i does not own merchandise j Because each piece of merchandise is owned by only one bidder, it is necessary that for every j=1,2, . . . m:
1=Σ_{for i=1,2, . . . b} o[i,j] (eq Own-1)
and for every i=1,2, . . . b
0≦Σo[ij]≦m for j=1,2, . . . m
bidder “o” would be designated as the game operator. Thus o[0,3]=1 means that the operator owns piece of merchandise number 3.
2.3.3.2.1.16. The Advertising Table

This table includes the contents of the current ads, including the ads put forth by the operator, plus the allocated number of ad-spots for purchase in the next trading cycle.

2.3.3.2.1.1.17. The Lottery Prize

This is a record of the clearbits available for the lottery in the current trading cycle. The prize is the sum of all the clearbits credited to the operator in the previous trading cycle but any operator's owned clearbits (trading points) not distributed earlier. The sources are: purchasing of operator owned merchandise (all just introduced merchandise is owned by the operator), purchasing of ad spots, and betting on the lottery prize of the former trading cycle.

2.3.3.2.1.1.1.8. Sales History

For each item of merchandise, at each trading cycle, up to the last one, there is a value associated with it—in clearbits currency. That value is the latest sales figure for that item. This sales history is part of the trading cycle status.

2.3.3.2.1.1.1.9. Bidders' Transaction History

For each bidder, there would be a table showing the bidder's transactions:
1. merchandise bought—at which trading cycle, and for how much.
2. merchandise sold—at which trading cycle, and for how much.
3. lottery prize won—amount and at which trading cycle.
4. advertisement spots bought—at which trading cycle, and for which price.

The bidders history would not show failing bids: Not for merchandise, not for lottery prizes, and not for ad-spots.

2.3.3.2.1.2. Players' Input

The players are:

The Operator

The Sellers

The Bidders

The sellers have no input to offer.

2.3.3.2.1.2.1. The Operator's Input

The Operator's input is:

Adjusting the bidding status for each piece of merchandise owned by it.

Determining the number of advertising spots available for bidder's purchase.

Posting messages for the other players.

2.3.3.2.1.2.2. Bidders Input

The bidders specify the following:
1. Bidding values for the various pieces of merchandise
2. Threshold values for owned merchandise.
3. Lottery Tickets
4. Advertising spots bidding
   2.3.3.2.1.3. The Players' Visibility Filter

The players may have restricted visibility of the status data. The filter operation takes the full status as input and produces a reduced version as output. This filter is described as part of the trading cycle algorithm (status display construction).

2.3.3.2.2. Trading Cycle Algorithms

The Trading Cycle Algorithms, (TCA), operate on the input status and the players' input to produce the output status. (see drawing #-5)

The TCA divide into the following parts:
1. Integrity Check
2. Ownership Matrix Processing
3. Lottery Processing
4. Ad Processing
5. Trading Cycle Status Construction.
   2.3.3.2.2.1. Integrity Check

The trading cycle algorithm, TCA, would first check the integrity of the player's input with respect to:
security integrity
accounting integrity

In practice the Integrity checks can be applied as soon as the player's data arrives, rather than wait for the starting time of the trading cycle. This would allow the operator to rectify any problem detected in the integrity check. The affected bidders could resubmit their data, rather than be excluded from this trading cycle.

2.3.3.2.2.1.1. Security Integrity Check

When TradeChess is played remotely, there is a need to verify the identity of the bidders' communication to insure (1) that there is no identity theft, and (2) that the bidder can not repudiate his input.

Any of the standard security checks can be applied here, and the selection depends on the security threat, the stakes, and the risk level chosen by the operator.

2.3.3.2.2.1.2. Accounting Integrity Check

Bidders who commit clearbits to a deal, or a prospective deal must have them. The accounting integrity check would verify this fact. If the verification fails, biddings would be ignored. Similarly, this check would confirm that a bidder who setup a purchase threshold for an article indeed owns that article, and thus has the right to set a purchase threshold thereto.

Let Xᵢ be number of clearbits assigned to bidder i=1,2, . . . b. as listed in the input status report.

Let yᵢⱼ be the number of clearbits assigned by bidder i to article of merchandise j=1,2, . . . m

Let Lᵢ be the number of clearbits assigned by bidder i for the lottery in this trading cycle.

Let Adᵢ be the number of clearbits assigned by bidder i for bidding on an ad-spot for the next trading cycle.

The accounting integrity check would verify that the following relationship holds for each given bidder, i:
Xᵢ≧Lᵢ+Adᵢ+yᵢ₁+yᵢ₂+ . . . . yᵢₘ
2.3.3.2.2.2. Ownership Matrix Processing

The ownership matrix, O[b,m] would be processed as follows: For every article of merchandise j=1,2, . . . m do:

1. Establish the purchase bidding for that article, from all b bidders:
Y*j=y₁ⱼ, y₂ⱼ, . . . y_{bj}

If a bidder, i, has not submitted a bit for that article than, set:
yᵢⱼ=0
2. Rank-Order Y*ⱼ such that yᵢⱼ is ranked at position, r, designated as yᵢⱼ^{r}. This ranking order, R, would satisfy the following conditions:

For every r′=1,2, . . . . b−1 and r″>r′ the following relationship would exist:
y_{i′j}^{r′}=y_{i″}^{r″}

And if:
y_{i′j}^{r′}=y_{i″}^{r″}
then, the following relationship would exist:
TA(i′)<TA(i′)

Where TA(i) is the time of admission of bidder i.

In other words, R, would rank order the bidding such that the highest bid is the first, and the lowest bid is the last, and the size of the bidding determines the relative position of that bidder. In the event that two bids are equal, then the bidder who was admitted earlier would be ahead in the ranking.

3. Establish the reference threshold vector:

3.1 If o[0,j]=1, then Th(j)=0

Meaning: if the article of merchandise is owned by the operator (bidder zero), then there is no threshold, the highest bid wins the article.

3.2 For all j=1,2,3, . . . m where o[0,j]=0 set:
Th(j)=∞
3.3 For all j=1,2, . . . m for which the input status designates a threshold value Thₛₜₐₜᵤₛ, set:
Th(j)=Thₛₜₐₜᵤₛ

Meaning: unless the current owner of an article of merchandise sets a threshold other than infinity, then the threshold is infinity.

The next steps depend on whether the article of merchandise is unique or a duplicate.

2.3.3.2.2.2.1. Unique Article Ownership Processing

For the article of merchandise in question, j,

If Th(j)>y_{i′j}¹

Then:

for all bidders i=1,2,..b set up:
o[i,j]_{input status}=o[i,j]_{output status}

Meaning: no change to the ownership of this article of merchandise.

Else, (namely Th(j)≦y_{i′j}¹), set up o[i′,j]=1, where i′ is the bidder index of the first bid in the rank-order, R, namely: y_{i′j}¹ is the highest bid.

For all i≠i′ set: o[i≠i′j]=0

In other words: if the highest bid is equal of higher than the purchase threshold, the bidder of that bid becomes the owner of that article of merchandise.

2.3.3.2.2.2.2. Duplicate Article Ownership Processing

A duplicate article, j=1,2,..m must be owned by the operator, hence: o[0,j]=1, and o[i≠0,j]=0.

Let d>1 be the number of duplicates offered by the operator for the current trading cycle.

The first article of the offered d duplicates would be assigned to bidder i(1), where yᵢ₍ᵢ₎ⱼ¹ is the first element in the R rank order. Namely: o[i(1)j]=1

The second article of the offered d duplicates would be assigned to bidder i(2), if any, where yᵢ₍₂₎ⱼ². Together with this assignment, the article would assume a unique identity, and become the next article, beginning with article m+1, in the article list, for the next trading cycle.

And similarly for the 3rd, 4th, etc. article, if any, up to article d, which would be assigned to bidder i(d), where y_{i(d)j}^{d}. Together with this assignment, each article would assume a unique identity, and become the next article, beginning with article m+1, in the article list, for the next trading cycle.

For all i≠i(1), i(2), i(3), . . . ,i(d), set: o[i,j]=0

In other words: Duplicate article may be offered only by the operator, and thus have no threshold. If d duplicates are offered, then the first d bidders in the rank-ordered list of bidding get to purchase a duplicate, and the rest do not.

2.3.3.2.2.3. Lottery Processing

Lottery processing is divided into:
1. Determining the current winner of the lottery.
2. Computing the prize for the next trading cycle.
   2.3.3.2.2.3.1. Determining the Current Winner of the Lottery

This determination is carried out as follows:

Let zᵢ be the betting sum paid by bidder i=1,2, . . . b for the prize listed in the input status.

1. Compute the betting total: Z
Z=ΣZ_{i for=1,2, . . . b}

2. Let g be an arbitrary integer, of choice, (determined in the pre-processing phase).

3. Let RND be a pseudo random number in the range 1—gZ.

4. Compute RND*=RND mod Z

5. The winner of the lottery is bidder i*, which satisfies:
Σ(zᵢ)_{for i=1,2}, . . . i*−1<RND*≦Σ(zᵢ)_{for i=1,2, . . . i*}

Note: The pseudo random number generation in (3) above must be a reproducible algorithm so that the entire procedure can be replicated if it's called for. This procedure is operates such that the winning chances are proportional to the amount invested in lottery bidding.

TradeChess: 2.3.3.2.2.3.2. Computing the Prize of the Next Trading Cycle

This is computed as the sum of the purchase prices of articles of merchandise which were purchased from the operator, plus purchasing money for ad-spots, plus lottery betting.
Zₙₑₓₜ=Σ(Adᵢ+zᵢ)_{for j=1,2, . . . m}+Σ_{j=1 to m}Σ_{r=1 to dj}y_{i′j}^{r}
where dⱼ is the number of duplicates for article of merchandise j. For non duplicate merchandise j, dⱼ=1. Ad(i) is the advertising bid of bidder i, and zᵢ is the lottery bidding of bidder i
TradeChess: 2.3.3.2.2.4. Ad Processing

Let Adᵢ be the bidding of bidder i for an ad-spot in the next trading cycle.

Let Ra be the rank-order of Ad₁, Ad₂, Adᵢ in a way analogous to the rank ordering of the purchase bidding of the merchandise, namely:

Rank-Order Adᵢ such that Adᵢ is ranked at position, r, designated as Adᵢ^{r}. This ranking order, Ra, would satisfy the following conditions:

For every r′=1,2, . . . b−1 and r″>r′ the following relationship would exist:
Ad_{i′}^{r′}≧Ad_{i″}^{r″}
And if:
Ad_{i′}^{r′}=Ad_{i″}^{r″}
then, the following relationship would exist:
TA(i′)<TA(i′)

Where TA(i) is the time of admission of bidder i.

In other words, Ra, would rank order the biddings such that the highest bid is the first, and the lowest bid is the last, and the size of the bidding determines the relative position of that bidder. In the event that two bids are equal, then the bidder who was admitted earlier would be ahead in the ranking.

Let a be the number of allocated ad-spots for the next trading cycle. The bidders who would end up purchasing an ad spot would be the first a bidders on the Ra ranking list. In other words, all bidder i* such that Ad_{i*}^{r*} is such that 1≦r*≦a would be allocated an ad-spot, and non other.

TradeChess: 2.3.3.2.2.5. Trading Cycle Status Construction

This action would take the results of the former parts, and use them to reconstruct the new status. Parts of this new status would then be constructed in a display aimed for the bidders, and onlookers.

The elements for status construction are the following:

The merchandise list : Adding new merchandise by the operator, and adding duplicate items of merchandise purchased by a bidder, as well as optionally removing any item of merchandise still owned by the operator.

The bidders list: Adding new bidders, if any. These are people or organizations who watch the ongoing game, and decide to pay the admission fee, and join in.

The clearbit vector: After running the other parts of the algorithm, this part would compute the number of clearbits credited to each bidder. The computation would be as follows:

For each bidder:

Take the starting capital—the number of clearbit available to the bidder, as indicated in the input status, Zᵢ, and detract from it, the following:
clearbits used to buy merchandise
clearbits used to bet on the current lottery.
clearbits used to buy ad-spots

Then add:
clearbits won in the lottery
clearbits paid by another bidder buying merchandise from this bidder.

And the result is the clearbits credited for this bidder in the output status.

The threshold vector: Owners of merchandise can change their threshold instructions for merchandise they own. Such new instructions serve to update the threshold vector.

The Ownership matrix : The ownership matrix is generally updated in the Ownership Matrix Processing. Additional updates account for:
added bidders
added new merchandise
added merchandise entries from former duplicate merchandise.
removed merchandise

Only merchandise owned by the operator can be removed (by the operator). Merchandise which was introduced as a duplicate item will appear as a unique item when it is bought by a bidder who may offer it for sale to the other bidders.

The Advertising table: The content input to the ad-spots bought in the previous trading cycle, will be posted for display, as well as the number of ad-spots available for sale in the next trading cycle. Also the advertising message issued by the operator will be part of this table. The allowed contents, whether text-only, or graphics-included, would be determined in the operator's rules, set forth in the pre-processing stage.

The Lottery Prize: The lottery prize for the next trading cycle will comprise all the clearbits credited to the operator, namely:
1. clearbits paid by bidders buying from the operator.
2. clearbits paid in betting on the previous lottery.
3. clearbits paid to buy an ad spot.

Sales History: For each article of merchandise add the current value, which is computed as follows:
1. If the item of merchandise did not change hands, its value does not change.
2. If the item of merchandise did change hands, then, its latest sale price is its new value.

Bidders' Transaction History: For each bidder, the transaction history would be updated, showing new merchandise bought, if any, owned merchandise sold, if any, lottery prize won, if any, and ad-spots bought if any.

TradeChess: 2.3.3.2.2.5.1. Trading Cycle Status Construction

This action amounts to building a display of selected items from the output status computed in the previous parts of the trading cycle algorithm.

The format depends on the TradeChess environment. If it is Internet based, then the display would be in the form of a WEB page.

The information visible to the players is controlled by the operator. A generic construction would be:

The Ownership Matrix

Parts of the merchandise list: merchandise name, description, type: unique/duplicate, number of available items. Only “biddable” items would be displayed. The seller information would be withheld, unless some of it appears in the description section. Sales History for all items of merchandise.

The current lottery prize (to be won in the next trading cycle).

Parts of the Bidders List: handles only, no names or other identifiers, or communication info, except the handles.

Bidders Transaction History.

Number of ad-spots available for bidding.

The bidders display would NOT reveal the clearbit vector, nor the threshold vector.

TradeChess: 2.3.3.2.3. Trading Cycle Time Line

Let a trading cycle begin at time point T′, which is also the end point of the previous trading cycle, and end at time point T″, which is also the beginning point of the next trading cycle.

At the first short ΔT, the trading cycle algorithm would kick in, and operate on the current status (generated in the previous cycle), to produce a new status. The new status would be visible in full by the operator, and be visible in part (through the visibility filter, or the display construction algorithm), to the bidders. From T′+ΔT to To, the trading cycle would feature the operator's input interval. That is the time for the operator to generate its input. At time point Tₒ, the trading cycle algorithm is re-operated to generate the final status for this trading cycle. It is based on the previous status plus the input from the operator. From time point To to T″, the bidders have the opportunity to generate their input, which at time point T″ is acted upon together with the status. This action is already the first action of the next trading cycle.

TradeChess: 2.3.3.3. The First Trading Cycle

The first trading cycle is characterized by the fact that it has no preceding cycle that generates its input status, and thus, that status must be generated otherwise.

The operator would generate the first status as follows:

The Ownership matrix: The starting set of m items of merchandise, as well as the starting set of b bidders, where the “o” bidder is the designation of the operator, would serve to construct a starting ownership matrix O[b,m] defined as follows:
O[b=0,i]=1; O[b>0,i]=0 for I=1,2, . . . m
Which expresses the initial ownership situation: the operator owns all the merchandise.

The merchandise list : The merchandise list would be constructed normally. There is no distinction for the first status, except that in the beginning all pieces of merchandise are owned by the operator and thus the operator has full discretion as to their inclusion in the list. Once a piece of merchandise is sold to a bidder, the operator loses his discretion to remove that merchandise from the list.

The bidders list : This list will features all the bidders who joined the game before it began.

The clearbit vector: This vector will indicate the number of clearbits initially credited to each bidder.

The threshold vector: This vector will be populated with zeros, because all merchandise, in the beginning are owned by the operator, and are sold without any threshold.

The Advertising table This table will feature the initial message of the operator to the bidders, as well as the number of advertising spots available for sale for the 2^{nd} trading cycle.

The Lottery Prize: This prize would be zero, in the beginning there are no clearbits owned by the operator.

Sales History: No history.

Bidders' Transaction History: no history.

TradeChess: 2.3.3.4. The Last Trading Cycle

The last trading cycle generates the final game status. It is the status that determines the game's outcome.

The only part of the last status that has any lingering significance for the bidder is the ownership matrix. The sellers are also interested in the sales history, or rather the latest sales figures of the merchandise.

The clearbit vector, the threshold vector, the advertising table, the lottery prizes—all become meaningless in the last status.

TradeChess: 2.3.4. The Settlement Process

When the last TradeChess status is registered, the transaction phase ends, and the settlement phase begins.

The settlement phase divides into three consecutive parts:
the disposition announcement
the challenge period
the delivery period.

After the last TradeChess status is registered, the operator computes the final disposition of the game's assets: pay to the sellers, and merchandise to the bidders, (as well as unsold merchandise return to the seller, remuneration to beneficiaries, to the game owner, and profit and expense coverage for the game operator). The disposition would be made accessible to all players. This would begin the challenge period, in which the players would have the right to challenge the final disposition. When all challenges are resolved the delivery period begins. During this period the operator would pay the sellers their due, and make available the goods to their buyers. If the buyers fail to claim their goods within the delivery period, then the goods become the property of the operator. The duration of each period, as well as the challenge resolution procedures are determined in the pre-transaction phase.

TradeChess: 2.3.4.1. The Final Disposition

During this short period, the operator would compute the final disposition. The registered owners of the merchandise would be the final owners. All buyers would be entitled to the merchandise registered to their name in the final ownership matrix. The sellers pay would be computed as follows:

1. Tally the value of all merchandise from the sales history table.

Let sⱼ be the last sale (and hence the value) of item of merchandise, j=1,2,3, . . . m.
Compute: S=Σ_{for j=1,2}, . . . , msⱼ

2. Tally the sum of the admission fees of all bidders: 1,2, . . . b
Af=ΣAf_{i for i=1,2, . . . b}

3. Discount the following from the sum of the admission fee
operating expense, OE
royalties, Ro
profit, or gain, Prf.
beneficiary pay, Bnf.
   As=Af−OE−Ro−Prf.−Bnf.

As, is the net sum destined for distribution among the sellers.

4. Compute payment for each seller, as follows:

Seller of merchandise j=1,2,3, . . . m would be allocated:
$Pⱼ=sⱼ*As/S

All this computation would be concluded in a short ΔT time, specified in the pre-processing phase. When done the results would be made public as the final disposition announcement.

TradeChess: 2.3.4.1.1. Discounts

The various discounts are:

operating expense, OE

royalties, Ro

profit, or gain, Prf.

beneficiary pay, Bnf.

TradeChess: 2.3.4.1.1.1. Operating Expenses

These expenses include

cost of labor—technical, administrative, executive, sales

cost of computing—hardware, software, maintenance, support

cost of communication—hardware, software, maintenance, support

office expenses—rental, supplies, utilities

business travel

promotion—advertising, promotional deals, indirect promotion.

legal expenses—arbitration, consulting, court proceeding, if any.

TradeChess: 2.3.4.1.1.2. Royalties

If the operator is other than the owner of TradeChess then the operator owes royalties to that owner, whether a licensee or a franchisee.

TradeChess: 2.3.4.1.1.3. Profit

The profit is the motivation for the operator to run the TradeChess game. It may be computed as a percentage (e.g.: 10%) of the admission fee revenue. If the operator is a non-profit organization then the profit is zero.

TradeChess: 2.3.4.1.1.4. Beneficiary pay

The TradeChess game may be operated on behalf of a nominal beneficiary, and a portion of the admission revenue must be paid to that beneficiary.

Examples are TradeChess games conducted in favor of a banner charity, a sponsoring event, etc.

TradeChess: 2.3.4.2. The Challenge Period

From the moment when the final disposition is announced, and until a time T_{ch} afterwards, there exists an opportunity for any player to challenge the final disposition. This challenge would be first met with a reply originated by the operator. A discussion would follow. If the challenger is satisfied, the case is resolved. If the satisfaction involves some changes to the final disposition, then the new final disposition is announced, and another, same length challenge period starts. This may repeat itself until such time that a challenge period passes and there is no challenge. This would conclude the challenge faith.

The length of the challenge period is setup in the pre processing phase.

If the challenge is not resolved through reasonable negotiations between the operator and the challenger then an arbitration procedure would kick in.

As the ruling of the arbitration agent comes down, the challenge period comes to its end.

TradeChess: 2.3.4.2.1. Arbitration Procedure

The operator would designate an auditor and arbitration agent, which may be one and the same. Their responsibility would be to audit and review the TradeChess game, which the operator can replay “blow-by-blow”, and evaluate it vis-à-vis the rules of the game. Based on their evaluation they would render a judgment, with respect to any challenge, for the final disposition of the game's assets. The loser in the ruling of the arbitration would pay the cost thereof. If the parties share the blame, that share would be reflected in their cost of arbitration liability. The two parties would put in escrow with the arbitration agent, the estimated cost of the arbitration, (as estimated by the arbitration agent), and the winning party would get their escrowed funds back.

TradeChess: 2.3.4.3. Delivery Period

Following the end of the challenge period, there would a period in which the sellers must be receiving their pay, and the buyers must be receiving their merchandise. The operator would act with both types of players in accordance with the agreement executed with each regarding the final disposition. In general the operator will pay by check, wire, or credit, the seller's due, and would make available the merchandise to the buyers' at operator's office, or send it to the buyer at buyer's expenses for shipping and handling.

If a buyer does not claim his merchandise within the delivery period, then the merchandise becomes the property of the operator. The length of the delivery period is setup in the pre-processing phase.

TradeChess: 2.3.5. Player's Objectives

The players are:

The game owner

The game operator/licensee/franchisee

The game beneficiary

The game sellers

The game buyers

Their objectives differ.

TradeChess: 2.3.5.1. The Game Owner

The owner's objective is to make the game popular so as to increase his license and franchise income.

TradeChess: 2.3.5.2. The Game Operator

His objective is to make the game rewarding so that he can run more of the same, and create a revenue stream from it.

TradeChess: 2.3.5.3. The Game Beneficiary

His objective is to increase the revenue of this particular game, since his benefit is proportional to the intake, or what is the same to the number of bidders.

TradeChess: 2.3.5.4. The Game Sellers

The game sellers aim to get maximum pay for their merchandise. Their latitude is limited to when they offer their merchandise to the operator. The operator can receive their merchandise and not put it for sale for as many trading cycles as he desires.

The more bidders there are, the greater the pool of money for the sellers, and the more attractive the game to the sellers.

TradeChess: 2.3.5.5. The Game Buyers

Their aim is to either own one or more particular pieces of merchandise, or to own as much as possible from the offered goods. Once they pay the admission fee, they have no more real currency consideration.

TradeChess: 2.3.6. Rules of the Game

We discuss:

procedure adherence

questionable conduct

visibility rules

TradeChess: 2.3.6.1. Procedure Adherence

The basic rules of the game are defined in the procedure of the trading cycles, and related steps. It is worth to emphasize that the sellers who offer their merchandise to the operator can not demand that their merchandise would appear as biddable in any particular trading cycle. This decision is solely in the hands of the operator. The operator, in his discretion may remove any item of merchandise which he owns, that is, items that were not purchased by any bidder. Bidders may not request their admission fee back if they fail to purchase anything. One important policy decision for the operator is how to handle the balance between “rich” and “poor”. If one allows bidders to purchase as many trading points as they like (commensurate, say, with their admission fee), then few “rich” bidders can easily overwhelm a majority of “poor” ones, and secure all the merchandise to themselves. This specter might deter “poor” bidders from joining in, in the first place. Because, unlike an auction where losers don't lose their bidding money, in TradeChess unsuccessful bidders do lose their admission fee. An alternative might be to limit the bidders options to a few admission fee levels. A “rich” bidder may not purchase more points than the highest admission fee would allow. He can buy many such “bidding personalities” and strategize with them, but each of those personalities would have to bid on his or her own. In other words, the bidder that bought the highest admission fee (the highest allowable number of trading points), and registered first, would be able to secure whichever article of merchandise he or she desires from the initial slate of merchandise. And no “rich” bidder could challenge him. Such policy would give rich bidders an advantage, but not an overwhelming one.

TradeChess: 2.3.6.2. Questionable Conduct

The game is resilient to a host of ‘cheating tricks’.

For example:

A seller may become a bidder in an attempt to jack up the price for his merchandise. Bidders should not be held liable for misinformation in their advertisement. The operator, on the other hand should be truthful. Alas, the operator may use advertising to suggest pending new merchandise in coming trading cycles, and that advertising may be vague, even embellished, but not patently untrue.

TradeChess: 2.3.6.3. Visibility Rules

The operator will have at his discretion the power to change the visibility filter for the bidders. At a minimum the bidders would see the sales history and bidders transaction history for all merchandise and bidders. The discretion applies to the clearbit vector, to the threshold vector, to the unsuccessful bidding amounts, and lottery tickets bought. This visibility can change from trading cycle to another, and the changes would be a tool for the operator to keep the game viable.

3. Analysis

We discuss:
the “thrill” factor
cheating
security
mathematical analysis
   3.1. The Trill Factor

The success of TradeChess depends on its “thrill factor.”

We define the thrill factor as the ability of the operator to keep the game challenging and unpredictable throughout its life time. Thrill, is all that the losers (bidders and sellers alike) would take out of the game. The losers—who make the game profitable to all others—must conclude that (1) the game had a meaningful entertainment value, and (2) that they learned something for next time, so that they can strategize better, and perhaps have better luck.

The risk of the game is that it dies down soon. Bidders buy their merchandise with all their clearbits, then drop out of the game, waiting for the final disposition. To counter that risk the game operator would have to promise and create the expectations for more ‘goodies’ to show up in subsequent cycles. That would make clearbits valuable throughout the game. Also, to that end, the operator should manage the visibility filter—what bidders know about each other, to allow them to strategize better.

A thrilling game would create an upward spiral effect. More bidders would join an interesting game, the more bidders join, the greater the take for the sellers, so more sellers are likely to offer their merchandise to the game, which would attract even more bidders, and that is the upward spiral. The operator would have to plan right the duration and the number of trading cycles to maximize this effect.

3.2. Cheating

Apart from the normal issues regarding false payment, and false identity (to claim merchandise or compensation), cheating may take place by hacking into the data vault of the game, and breaking through the visibility filter of the game status—this is addressed as a security issue.

Other forms of cheating are:
two or more bidders in cahoots
seller becomes a bidder to drum up his merchandise
misstatements in the advertising spots

All the above are allowed behavior, since it appears that the game structure is robust against too much damage from this behavior.

3.3. Security

The money and the merchandise would require normal security for such items. Hacking into the data vault of the operator to eye the hidden parts of the status, should also be protected with common means. Similar protection would have to be extended to the pseudo random number generation procedure, since if this is compromised it would give an undue advantage to the compromising bidder.

3.4. Mathematical Analysis

We discuss:
general mathematical attributes
simple to complex analysis
clearbits availability
merchandise release and disclosure strategy
   3.4.1. General Mathematical Attributes

Aspects:
1. The relationship between admission fee and sellers price
2. The low arbitrariness factor.
   3.4.2. Simple to Complex Analysis

The TradeChess game is quite complex. Mathematical analysis may start with simple arrangements and grow more realistic step by step.

We discuss:
One bidder, many items of merchandise
Two bidders, one item of merchandise
fewer bidders than merchandise
same number of bidders and merchandise
   3.4.2.1. One Bidder Many Items for Sale

This is the easies case, the bidder might bid the minimum on each item, and since there is no competition, the bidder would get all the merchandise, he would also be in a position to determine how much each seller gets.

This is the trivial case, and of no practical interest.

:3.4.2.2. Two Bidders One Item of Merchandise

If the two bidders have the same number of clearbits to start with, then the bidder who registered first would get the merchandise. Hence, if there is only one item for sale, once there is a single bidder, it makes no sense for additional bidders to join in, if they cannot purchase more trading points than the next bidder.

If, on the other hand, the bidders can purchase as many clearbits as they like (depending on the admission fee), then the case is reduced to a standard auction. Two or more bidders compete on how much to pay for an auctioned off piece of merchandise.

3.4.2.3. Fewer Bidders Than Merchandise

This situation lends itself to a clear rationalization if the items of merchandise may be universally ranked with respect to their value. Such is the case when the merchandise is cash. Suppose one piece of merchandise is $Q, the other is $(Q-1), then $(Q-2), up to $(Q-j). There are i bidders all with the same number of clearbits to start with. Bidder 1 registered first, bidder 2 registered second, and so on. In that case the rationalized outcome is that the first bidder would get the $Q prize, the second, the $(Q-1), and the i-th bidder, would get the $(Q-i+1). The other prizes are left unclaimed because no body would have clearbits left to buy anything. The above order applies because the first bidder would bid on the highest item, knowing that it's guaranteed to be his, since he registered the first. The second bidder would not compete on the $Q item, knowing he would lose to the first bidder that is likely to bid on it, so he would bid on the $(Q-1) item, and be guaranteed to get it because he would not compete on it with bidder 1. Similarly the i-th bidder would bid on the $(Q-i+1) item of merchandise. If the items of merchandise are not universally ranked, then the situation is much more complicated.

3.4.3. Clearbits Availability

TradeChess can be played with:
fixed number of clearbits per admission, without transfer.
fixed number of clearbits per admission, with transfer.
at will clearbit purchase, with some restrictions
at will clearbit purchase, without any restrictions

It would appear that there would be more excitement when the game is played with fixed number of clearbits per player with no sharing. In this case “rich” bidders would express themselves as many distinct bidders.

: 3.4.4. Merchandise Release and Disclosure Strategy

The operator must navigate between two opposing motivations. On one hand the operator would like to exhibit a most alluring list of merchandise to be had, when the game is announced, in order to lure in as many bidders as possible, on the other hand the operator may wish to leave some attractive merchandise for later in the game to keep the clearbits valuable, and to attract more bidders later on. Also, the operator may wish to decide how to reveal the coming merchandise, how specific should he be in describing them, and when they are coming.

The operator must remain truthful, to avoid a successful challenge and losing a subsequent arbitration.

4. Implementation

TradeChess can be played in a large variety of forms:
entertainment emphasized games
trade emphasized applications
beneficiary emphasized instances.
   4.1. Entertainment Emphasized Games

These are situations where the thrill is the critical reward.

A particular case is the TradeChess casino.

4.1.1. The TradeChess Casino

TradeChess can be implemented as a casino by allowing the merchandise to become cash prizes, or cash-equivalent.

The total amount of cash prizes would be computed as a cut from the admission fee pool.

The operator would decide how to parcel the total prize money to individual prizes, and when to introduce each prize.

4.1.2. Table Version

TradeChess can readily be used for around-a-table entertainment. A group of players equipped with some game props, and a computing device would play a slightly modified version.

There are two main categories for the table version of TradeChess:
the merchandise game
the cash game

We address each category below.

TradeChess: 4.1.2.1. Table Version Props

Each player would play a different color, and be playing with trading chips as trading points. The items for each player are:
1. trading chips
2. privacy shields
3. bidding cups
4. ownership strips

In addition, the game would include a pair of dice, a lottery bowl, and a trading cycle chart. The dice would be used to determine priority order among players. The lottery bowl would be used to house the lottery prize for the coming trading cycle. The trading cycles chart would be used to show which merchandise becomes biddable at which cycle.

4.1.2.1.1. Trading Chips

Colored chips. For example:
1. 30 chips rated 1 point each, totalling: 30 points
2. 7 chips rated 5 points each, totalling: 35 points
3. 6 chips rated 10 points each, totalling: 60 points
4. 3 chips rated 25 points each, totalling: 75 points
5. 1 chip rated 50 points, totalling: 50 points

Total points per player: 250 points

4.1.2.1.2. Privacy Shield

An opaque folding table wall enabling a player to organize his chips (trading points) in privacy.

: 4.1.2.1.3. Bidding Cups

Plastic cups marked with the player's color, which are used upside down while covering the chips a player uses for bidding or for gambling on the lottery. The bidding money hidden under the upturned cup is placed near the bid merchandise or near the lottery bowl, and when the operator says so, the cup is removed and the chips are counted, and compared to other biddings.

: 4.1.2.1.4. Ownership Strips

Plastic strips to mark an item as belonging to the particular colored player.

TradeChess: 4.1.2.2. Table Version Computer

This computer can be dedicated, or may be a PDA, a laptop, or other general purpose computer.

Computing tasks are:
1. instant lottery calculator
2. cash divider
   : 4.1.2.2.1. Instant Lottery Calculator

This is a simple task designed to determine the winner of a lottery so that each player would have his chances proportional to the money invested in the lottery.

This computation may follow the random number generation procedure described above.

An alternative would be as follows:

Let n players place bids on winning the current lottery. Bidder i=1,2,..n places xᵢ trading points. Let the bidders be designated by i=1,2, . . . n such that for every i=1,2, . . . (n-1) it will be true that:
xᵢ≦xᵢ₊₁

1. Compute Y, as the multiplication of the bids:
Y=Π_{i=1,2, . . . n}(xᵢ), for all xᵢ>0

2. Compute “the needle point”, Z, the primitive root in the equation:
Z−Y² mod (Σ_{i=1,2,..n}(xᵢ))

3. The winner is bidder j, which satisfies:
Σ_{i=1,2,..j-1}(xᵢ)<Z≦Σ_{i=1,2, . . . j}(xᵢ)

Example: Four bidders bid on the lottery as follows: 12, 4, 11, 7 trading points.

We organize the bidding by the amount bid:
bidder 1 amount bid: 4
bidder 2 amount bid: 7
bidder 3 amount bid: 11
bidder 4 amount bid: 12

1. Computing Y=4*7*11*12=3696

2. Computing Z:
36962 mod (4+7+11+12) 13,660,416 mod 34=32

Since we have:
4+7+11<32≦4+7+11+12

We conclude that bidder 4 is the winner.

It's easy to see that if, for instance, bidder 2 would have bid 8 points, instead of 7, then bidder 3 would end up the winner. Since no one knows how much the other is bidding, the winner appears random.

4.1.2.2.2. Cash Divider

This task would process a cash sum of $Z into prescribed n parts: x₁, x₂, x₃, . . . xₙ such that:
Z=Σ_{i=1,2, . . . n}(xᵢ)

The division would proceed as follows:

1. Compute the “selection field”, F
F=Z−(n−1)

2. Apply a random number generator to select a random number between 1 and F, G. Set
x₁=G

3. Re-compute the selection field, F:
F=Z−xₓ−(n−2)

4. Apply a random number generator to select a random number between 1 and F, G. Set
x₂=G

5. Re-compute the selection field, F:
F=Z−x₁−x₂−(n−3)

6. Apply a random number generator to select a random number between 1 and F, G. Set
x₃=G

Repeat, and determine xⱼ for j=1,2,..(n−1) by:

7. Re-compute the selection field, F:
F=Z−Σ_{i=1,2,..(j-1)}xᵢ−(n−j)

8. Apply a random number generator to select a random number between 1 and F, G. Set
xⱼ=G

9. Determine xₙ as follows:
xₙ=Z−Σ_{i=1,2,..(n-1)}xᵢ

Example: Divide a pool of Z=$100 to 6 parts:

1. compute F=100−5=95

2. Set G as a random selection between 1-95:
G=RND(1-95)=14
x₁=G=14

3. Recompute the field, F=100−14−4=82

4. Compute G as a random selection between 1 and 82:
G=RND(1-82)=32

Set x₂=G=32

5. Recompute the field, F: 100−(14+32)−3=51

6. Compute G as a random selection between 1 and 51:
G=RND(1-51)=12

Set x₃=G=12

7. Recompute F=100−(14+32+12)−2=40

8. Compute G as a random selection between 1 and 40:
G=RND(1-40)=4

Set x₄=G=4

9. Recompute F=100−(14+32+12+4)−1=37

10. Compute G as a random selection between 1 and 37:
G=RND(1-37)=30

Set x₅=G=30

11. Compute the last part as follows:
x₆=100−(14+32+12+4+30)=8

This concludes the computation. The sum of $100 was randomly divided into 6 parts as follows: $14, $32, $12, $4, $30, $8

4.1.2.3. The Merchandise Game

Each player brings to the table one, two or more articles “for sale”. The group agrees on a range of values for these articles. The articles are passed around, for everyone to check them out, and then they are displayed on the table as merchandise for sale. To play, each participant puts up a fixed amount of cash, say $10.00 each. Suppose, 5 people play, this translates to $50.00 in the game's account. In return to his admission fee, a player receives, say 100 trading points, in the form of chips, but which may also be simulated by actual cash, pennies, nickels, dimes. One player is selected as the game operator. The group agrees on the fixed number of trading cycles, say, 8, and on a “Russian Roulette” thereafter. Each player hides his coins (trading points) behind a physical barrier. Also each player has an identifying color. Every player has several cups all painted by his or her color.

Before trading begins the players need to determine their order of priority. This order is in lieu of the registration date in the Internet version. It is used solely to settle a conflict of same bidding amount. If two bidders bid the same number of chips on a piece of merchandise, the one with the order priority gets the merchandise. And thus the player must execute a priority order procedure before the game.

Another pre-game procedure involves the schedule of presentation of the merchandise. If the players agree on t guaranteed trading cycles (before the Russian roulette cycles), then the m pieces of merchandise must be allocated to one of these t cycles for initial presentation. That is the cycle in which that particular piece of merchandise would be eligible for bidding. The schedule must be clearly displayed for all to see. In each trading cycle, each player hides as many trading points as he or she desired, under his upturned cups, and moves this cup (still upside down) to the vicinity of the article he wishes to bid on. He or she may bid on their own article. In the first trading cycle, that is all that is happening. When every one placed his bid, the operator announces that bidding is over, and he turns up the cups, and determines who acquired which article. Before the first trading cycle, each article was marked with a white strap, where white is the color of the operator (the player that doubles as operator). When the first trading cycle is over, each article is marked with a strip that indicates the color of the new owner of the article. The operator has his or her player color, apart from white. The second round proceeds the same way. The difference is that in it the operator puts up the coins (trading points) he collected from the winning bidders, for a lottery round. In the second and all other rounds, the players have a chance to buy lottery tickets. They place the amount of trading points they choose for the lottery in another upturned cup marked with their color. When the bidding time is done, the operator unveils the amounts placed for the lottery, and keys them in, to a computer program that operates on a dedicated game computer, or on a PDA, a laptop etc., and runs the calculations to determine who wins the lottery. A similar procedure would be run for the “Russian Roulette” trading cycles.

The lottery in each trading cycle includes all the chips that were collected by the operator thus far. The game is over when the Russian roulette cycle is determined to be the last one, by the roll of the dice (or any other random selection), or when the maximum allowable cycles for the Russian roulette phase has arrived.

When the game ends, each successful bidder walks away with the pieces of merchandise he outbid the others for. The pool of cash, (e.g. $50 in the example above), is divided according to the value of each merchandise as indicated by its last trade.

The objective of the game is to walk home with as many desired items of merchandise as possible, plus as much cash as possible.

Since the players all bring on merchandise of similar value, the real competition is about finding something that the rest of the people want dearly—and would bid highly for, increasing the cash remuneration to the player who brought that item.

For instance, a group of poetry lovers would each bring 2 or 3 poetry books to the game. The players will have a chance to examine the collection, and bid according to their preference. The player who would bring along the most attractive poetry book will walk away with most of the money.

In this table version the advertising option is dropped. Players can freely communicate with one another.

Priority Order Procedure

Priority order may be agreed upon by, say, order of arrival to the game, or it may be decided randomly with a dice. For up to six players one dice is enough, for 11 two dice are needed etc.

Each player in his turn rolls the dice. The players are ordered by the outcome of the dice. If two, or more players roll the same face, they sort themselves out via another round of dice rolling among them only.

. The Russian Rollette Table Version

After each trading cycle after the guaranteed fixed number of cycles, the operator would roll a dice. If it falls on 6, then there are no more trading cycles. Otherwise there is another cycle.

4.1.2.3.3. Merchandise Bidding Schedule

Given m pieces of merchandise, and t regular trading cycles, the operator must allocate each of the merchanise items to a particular trading cycle.

The allocation can be done any which way. Alas, to maintain interest and thrill in the game, the operator may wish to follow the following guidelines:

1. Start trading with at least 2, preferebly 3, or more merchandise items.

2. Reserve at least 2, preferebly 3, items of merchandise for the last regular trading cycle.

3. Avoid introducing a single piece of merchandise on a given trading cycle, use two or more items together.

These guide lines suggest that 9-12 items of merchandise are a comfortable minimum.

4.1.2.4. The Cash Game

The cash game is played like the merchandise game with one difference: the merchandise is replaced with bundles of cash. The property of cash is that its only attribute is its sum, and all players want more of the same. This difference leads to more streamlined strategy options.

In the cash game, n players each pays a fixed admission fee, Af. The total sum of n*Af dollars is distributed among the agreed upon t trading cycles. One player is chosen as the operator, and he first runs the cash-divider algorithm to divide Af into p parts (the value of p is agreed upon, and is recommended to be at least 10 or 12). Subsequently, in his, or her discretion, the operator distributes these parts across the trading cycles. Next, the players roll the dice or activate any other procedure to rank order themselves, so that in case two bidders bid the same amount, the ranking would determine the winner.

At this stage the players may start playing. All cycles are good for lottery operation. If the lottery variety is used then even if the first or first few trading cycles do not have a cash bundle to bid on, the players may play the lottery, getting ready for the bidding.

When the last trading cycle is played, the cash bundles go to their new owners. The entire sum is now re-divided among the players. The redistribution of the money makes for winners and losers. The players can readily turn around and play another game. (See drawing #-6).

4.1.2.5. Lottery Variation

The table game can be played with a slight variation for its lottery component. At each cycle the money used to buy lottery tickets would be subject to lottery winning at the very same cycle—along with all other trading points accumulated by the operator at the time.

This variation would allow the players to start the game with a trading cycle which has no merchandise to bid on. The game would be comprised solely of gambling. This would create a point spread among the players, and make the game more exciting.

4.2. Trade Emphasized Applications

This utility application would promote trade owing to:
1. the seller getting more from his merchandise
2. the buyer paying less for his merchandise
3. sellers getting sales where they could not otherwise.
4. buyers finding merchandise which they could not have found otherwise.
   4.3. Beneficiary Emphasized Instances

These are cases where an event organizer, a web-based magazine or site, is vying for attention based on the attraction of TradeChess. In these cases, the entertainment value and the rewards to the buyers are prime.

What is claimed is:

1. A game-formatted trade environment where unlimited number of sellers and unlimited number of buyers interact for the purpose of exchanging goods for money in a format that presents a limited (known) risk to both buyers and sellers, along with the opportunity for unlimited high-price for sellers, and the opportunity for buyers to buy, auction-style, very expensive goods against their fixed admission fee, and where the trade is transacted with game-currency that is given to buyers against their game admission fee, and is losing its value at game's end, so that buyers walk-away with the goods they purchased against the game currency, and the sellers divide among them the aggregate admission fee minus the profits of the game operator, and his cost, such that each seller receives a cut proportional to the purchase price of his or her goods as transacted with the game currency.

2. The trade-environment in claim 1 further comprising a series of trade cycles, where each trade cycle is further comprising bids and their resolution, lottery and its resolution, and advertising, and where the a bid is comprising secret offers to buy any merchandise for sale with as much available game currency as a prospective buyer (player) would possess, and be willing to use for that purchase, such that the highest bidder receives the bid-for goods against the bid sum of game currency which transfers to the owner of the merchandize, such owner is initially the game operator, and subsequently another player who purchased the merchandise in a former trade cycle; and where the lottery is carried out each cycle over the entire sum of game currency collected by the operator in the previous cycle, and where the chances of each player (prospective buyer) to win is proportional to how many lottery tickets he or she bought, where a lottery ticket sells for the unit of the game currency; and where the advertisement is put forth by the would-be buyers (players) on a purchased common area, which has room for a fixed number of advertisements, which is allocated first to the highest bidder for advertisement slot, then to the second highest bidder, etc, until the slots are sold out.

3. The trade-environment in claim 1 further comprising an operator's strategy such that the operator determines before each trading cycle, which of the merchandize available for sale in the game environment would be offered or withdrawn, for the game bidders, while any merchandize previously purchased by a bidder may be put up for bid by other bidders, or not, according to the wishes of the merchandise owner.

4. The trade-environment in claim 1 further comprising of the possibility of sellers and buyers to join the game before any trade-cycle; sellers would join by offering their merchandize for the game, accepting the risk of getting very little for their goods, and hoping to receive a sum larger than in regular trade environments, and buyers would join by paying nonrefundable admission fee, giving them the chance to successfully bid on a coveted piece of offered merchandise, while accepting the risk of not purchasing anything they desire, and thus losing their admission fee.

5. The trade-environment in claim 1 further comprising of certain rules, such as: (1) the number of nominal trade cycles would be preset before the game begins, but the actual number of trade cycles may be a bit higher as dictated by a randomization process; (2) If two bidders bid the same highest bid for a piece of merchandize then the bidder who joined the game earlier prevails, (3) any merchandize offered for the game is first owned by the game operator who would sell it to the highest bidder without any minimum threshold, (4) A bidder can bid as any number of virtual game bidders, (each paying the full admission fee, and receiving the same preset amount of game currency), but it would be impossible for a bidder to offer more than the standard admission fee for a larger amount of game currency.

6. The trade-environment in claim 1 implemented (1) with merchandize for bid in the form of cash or cash equivalent in nominal sums, (e.i.: dollars would be bought for game currency), (2) with merchandize that is one-of-a-kind, or otherwise without an objective measure of dollar value; and implemented to (i) stimulate the sale of hard-to-sell merchandise, or (ii) as a non-cash reward for volunteers who would get free admission against their services, or (3) implemented as a direct competition to auctions, lotteries, advertisement based sales, or in competition with any other trade environment.

7. The trade-environment in claim 1 implemented (1) through the World-Wide-Web via a dedicated game site, (2) through a private network with restricted players, or (3) through a board game for a group of players around a play table.
